(19) United States
(12) Patent Application Publication
(10) Pub. No.: US 2003/0228016 A1
(43) Pub. Date: Dec. 11, 2003

(54) Image encryption apparatus, image encryption method, decryption apparatus, decryption method, program, and storage medium

(75) Inventor: Takuya Shimada, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/455,444

(22) Filed: Jun. 6, 2003

(30) Foreign Application Priority Data
Jun. 7, 2002 (JP) 2002-167655

(51) Int. Cl. H04N 7/167

(52) U.S. Cl. 380/213

(57) ABSTRACT

In step S904, color signals which form input image data are converted into device-independent color signals (color signals X, Y, and Z) using an input profile. In step S905, the color signals X, Y, and Z are converted into color signals Re, Ge, and Be that form encrypted image data using an encryption profile.

### FIELD OF THE INVENTION

The present invention relates to an image encryption apparatus and method for encrypting an image, a decryption apparatus and method for decrypting an encrypted image, a program, and a storage medium.

### BACKGROUND OF THE INVENTION

Upon delivering/distributing high-resolution color image data, an encryption/decryption technique is used to appropriately limit users.

However, in order to use an encrypted image, i.e., display it, print it out, and so forth, that image must be decrypted in advance, and an encrypted image cannot be directly used in a general image processing apparatus/image processing software program. In general, since decryption requires a dedicated software program, a user must install this program, learn its operation method, and execute decryption every time he or she uses an encrypted image. Also, users of a decrypted image cannot be limited.

The present invention has been made in consideration of the above problems, and has as its object to provide an image encryption apparatus, image encryption method, program, and storage medium, which can limit users of an image, and allow decryption without requiring any special software program or apparatus.

It is another object of the present invention to provide a decryption apparatus, decryption method, program, and storage medium, which can easily decrypt an encrypted image without requiring any special software program or apparatus.

### SUMMARY OF THE INVENTION

The present invention has been made in consideration of the above situation, and has as its object to reduce the influence of gaps between photoelectric conversion element arrays on a read image by a simple and inexpensive arrangement.

According to the present invention, the foregoing object is attained by providing an image encryption apparatus for encrypting an image, comprising: first conversion means for converting a color signal group that forms a first image into a color signal group, that is independent of a device supplying the first image, on the basis of a first profile; and second conversion means for converting the color signal group, converted by the first conversion means into a color signal group that forms a second image different from the first image, on the basis of a second profile used for encryption which is different from encryption by the first profile.

According to the present invention, a decryption apparatus for decrypting an image encrypted by the above-described image encryption apparatus comprises: conversion means for converting the second image into a color signal, that is independent of the device supplying the first image, on the basis of the second profile; and output means for generating output image data on the basis of the color signal group converted by the conversion means, and outputting the output image data to an image forming apparatus.

According to the present invention, the foregoing object is attained by providing an image encryption method for encrypting an image, comprising: a first conversion step of converting a color signal group that forms a first image into a color signal group, that is independent of a device supplying the first image, on the basis of a first profile; and a second conversion step of converting the color signal group, converted in the first conversion step into a color signal group that forms a second image different from the first image, on the basis of a second profile used for encryption which is different from encryption by the first profile.

According to the present invention, a decryption method for decrypting an image encrypted by the above-described image encryption method comprises: a conversion step of converting the second image into a color signal, that is independent of the device supplying the first image, on the basis of the second profile; and an output step of generating output image data on the basis of the color signal group converted in the conversion step, and outputting the output image data to an image forming apparatus.

According to the present invention, the foregoing object is attained by providing an image encryption apparatus for encrypting an image, comprising: first conversion means for converting a color signal group that forms a first image into a first color signal group, which is independent of a device, on the basis of a first profile; second conversion means for converting the first color signal group into a color signal group on a color space of an image forming apparatus on the basis of a second profile which is different from the first profile; third conversion means for converting the color signal group converted by the second conversion means into a second color signal group on the basis of a third profile, which is used for encryption which is different from encryption by the first and the second profiles; and fourth conversion means for converting the second color signal group into a color signal group that forms a second image by executing inverse conversion of the conversion by the first conversion means on the basis of the first profile.

According to the present invention, a decryption apparatus for decrypting an image encrypted by the above-described image encryption apparatus comprises: fourth conversion means for converting the color signal group which forms the second image into a third color signal group on the basis of the first profile; fifth conversion means for converting the third signal group into a color signal group on the color space of the image forming apparatus on the basis of the third profile; and output means for generating output image data based on the color signal group converted by the fifth conversion means, and outputting the output image data to the image forming apparatus.

According to the present invention, the foregoing object is attained by providing a first conversion step of converting a color signal group that forms a first image into a first color signal group, which is independent of a device, on the basis of a first profile; a second conversion step of converting the first color signal group into a color signal group on a color space of an image forming apparatus on the basis of a second profile which is different from the first profile; a third conversion step of converting the color signal group converted in the second conversion step into a second color signal group on the basis of a third profile, which is used for encryption which is different from encryption by the first and the second profiles; and a fourth conversion step of converting the second color signal group into a color signal group that forms a second image by executing inverse conversion of the conversion in the first conversion step on the basis of the first profile.

According to the present invention, a decryption method for decrypting an image encrypted by the above-described image encryption method comprises: a fourth conversion step of converting the color signal group which forms the second image into a third color signal group on the basis of the first profile; a fifth conversion step of converting the third signal group into a color signal group on the color space of the image forming apparatus on the basis of the third profile; and an output step of generating output image data based on the color signal group converted in the fifth conversion step, and outputting the output image data to the image forming apparatus.

According to the present invention, the foregoing object is attained by providing an image encryption apparatus for encrypting an image, comprising: first conversion means for converting a color signal group that forms a first image into a color signal group on a color space of an image forming apparatus on the basis of a first profile; and second conversion means for converting the color signal group converted by the first conversion means into a color signal group that forms a second image different from the first image, on the basis of a second profile which is used for encryption which is different from encryption by the first profile.

According to the present invention, a decryption apparatus for decrypting an image encrypted by the above-described image encryption apparatus comprises: conversion means for converting the second image into a color signal group on the color space of the image forming apparatus on the basis of the second profile; and output means for generating output image data on the basis of the color signal group converted by the conversion means, and outputting the output image data to the image forming apparatus.

According to the present invention, the foregoing object is attained by providing a first conversion step of converting a color signal group that forms a first image into a color signal group on a color space of an image forming apparatus on the basis of a first profile; and a second conversion step of converting the color signal group converted in the first conversion step into a color signal group that forms a second image different from the first image, on the basis of a second profile which is used for encryption which is different from encryption by the first profile.

According to the present invention, a decryption method for decrypting an image encrypted by the above-described image encryption method comprises: a conversion step of converting the second image into a color signal group on the color space of the image forming apparatus on the basis of the second profile; and an output step of generating output image data on the basis of the color signal group converted in the conversion step, and outputting the output image data to the image forming apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of an image processing apparatus used in the first embodiment of the present invention, and also the arrangement with its peripheral devices;

FIG. 2 is a block diagram showing the functional arrangement of an image processing unit 120;

FIG. 3 is a block diagram showing the functional arrangement of an input profile conversion unit 201;

FIG. 4 illustrates gamma conversion executed by a gamma converter 301;

FIG. 5 is a block diagram showing another functional arrangement of the input profile conversion unit 201;

FIG. 6 is a block diagram showing the functional arrangement of an image encryption apparatus according to the first embodiment of the present invention;

FIG. 7 shows an example of a setup user interface (GUI) of a typical color printer program, which is displayed on a display unit 1705;

FIG. 8 is a block diagram showing the basic arrangement of an image encryption apparatus according to the first embodiment of the present invention;

FIG. 9 is a flow chart of an image encryption process executed by the image encryption apparatus according to the first embodiment of the present invention;

FIG. 10 is a block diagram showing the functional arrangement of an image encryption apparatus according to the second embodiment of the present invention;

FIG. 11 is a block diagram showing the basic arrangement of an image encryption apparatus according to the second embodiment of the present invention;

FIG. 12 is a flow chart of an image encryption process executed by the image encryption apparatus according to the second embodiment of the present invention;

FIG. 13 is a block diagram showing the basic arrangement of the image processing apparatus used in the first embodiment of the present invention;

FIG. 14 is a block diagram showing the functional arrangement of an image processing apparatus according to the third embodiment of the present invention;

FIG. 15 is a block diagram showing the functional arrangement of an image encryption apparatus according to the third embodiment of the present invention;

FIG. 16 is a block diagram showing the basic arrangement of an image encryption apparatus according to the third embodiment of the present invention; and

FIG. 17 is a flow chart of an image encryption process executed by the image encryption apparatus according to the third embodiment of the present invention.

### DETAILED DESCRIPTION OF THE PREFERRED EMBODIMENTS

Preferred embodiments of the present invention will now be described in detail in accordance with the accompanying drawings.

### First Embodiment

This embodiment will explain an image encryption apparatus which encrypts an image to be input to an image processing apparatus that receives an externally input image, and inputs an output instruction to an image output apparatus, which prints out the image on a print medium such as a paper sheet, OHP sheet, or the like. Of course, when an image to be input to the image processing apparatus is encrypted, the image processing apparatus cannot output satisfactory image data to the image output apparatus. Hence, this embodiment will explain a case wherein the image processing apparatus executes a decryption process for decrypting an image encrypted by the image encryption apparatus.

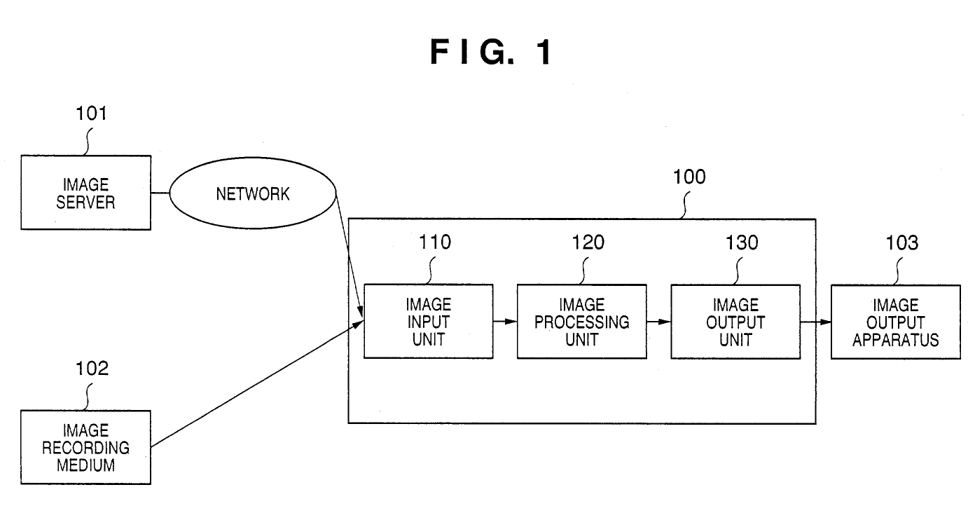

A general image processing apparatus used upon realizing advanced color reproduction will be explained first. FIG. 1 shows the functional arrangement of the image processing apparatus, and also the arrangement with its peripheral devices. Reference numeral 100 denotes an image processing apparatus which comprises an image input unit 110, image processing unit 120, and image output unit 130 (to be described later).

Reference numeral 101 denotes an image server which can make data communications with the image processing apparatus 100 via a network. Reference numeral 102 denotes an image recording medium such as a CD-ROM, DVD-ROM, or the like. Reference numeral 103 denotes an image output apparatus which prints an image, text, and the like on a print medium such as a paper sheet, OHP sheet, or the like on the basis of print data output from the image processing apparatus 100, and outputs the printed print medium.

Image data loaded from the image server 101 on the network or the image recording medium 102 to the image processing apparatus 100 is input via the image input unit 100, undergoes a color process by the image processing unit 120, and is then output as print data via the image output unit 130. The image output apparatus 103 prints an image, text, and the like on a print medium on the basis of this print data, and outputs the print medium. Typically, the image output apparatus 103 is a color printer which forms an image on a sheet surface using cyan (to be abbreviated as C hereinafter), magenta (to be abbreviated as M hereinafter), yellow (to be abbreviated as Y hereinafter), and black (to be abbreviated as K hereinafter) inks or toners.

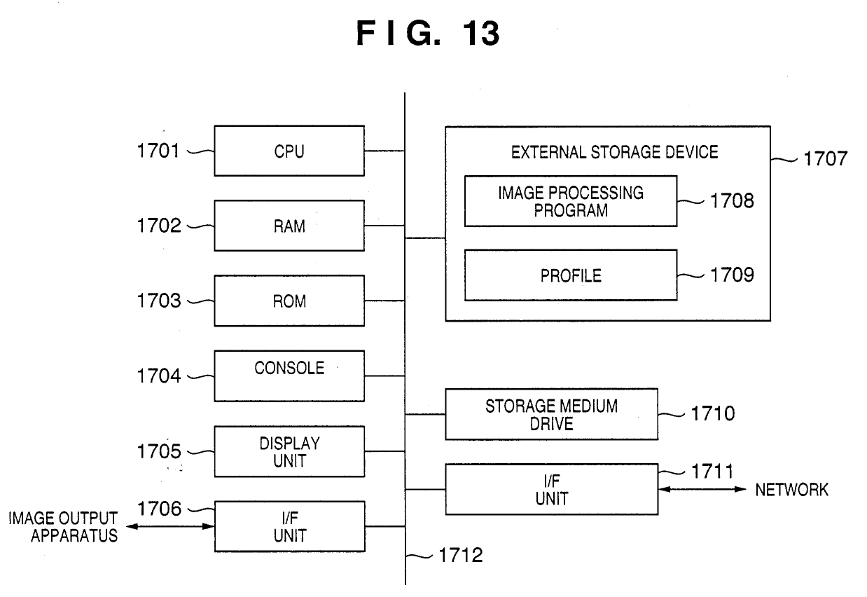

FIG. 13 shows the basic arrangement of the image processing apparatus. Reference numeral 1701 denotes a CPU which controls the overall apparatus using programs and data stored in a RAM 1702 and ROM 1703, and also executes respective image processes to be described later. Reference numeral 1702 denotes a RAM which has an area for temporarily storing program and data loaded from an external storage device 1707 and recording medium drive 1710, and various data of processes in progress, and also a work area used when the CPU 1701 executes respective processes.

Reference numeral 1703 denotes a RAM which stores programs and data used to control the overall apparatus. Reference numeral 1704 denotes a console, which includes a keyboard and a pointing device such as a mouse or the like, and can input various instructions to the apparatus. Reference numeral 1705 denotes a display unit which comprises a CRT or liquid crystal display screen, and displays various GUIs, images, and text. Reference numeral 1706 denotes an I/F unit which connects to the image output apparatus 103, and is used to output data to the image output apparatus 103.

Reference numeral 1707 denotes an external storage device which saves an OS, a program (image processing program 1708) required to execute various image processes to be described later, and various profiles 1709 to be described later. Note that the image processing program 1708 includes a color management system (to be abbreviated as CMS hereinafter), and a color printer control program. Reference numeral 1710 denotes a recording medium drive, which reads various data including an image from the image recording medium 102, and outputs them to the external storage device 1707 and RAM 1702. Reference numeral 1711 denotes an I/F unit, which connects to the network, and is used to make data communications with the image server 101. Reference numeral 1712 denotes a bus used to interconnect the aforementioned units.

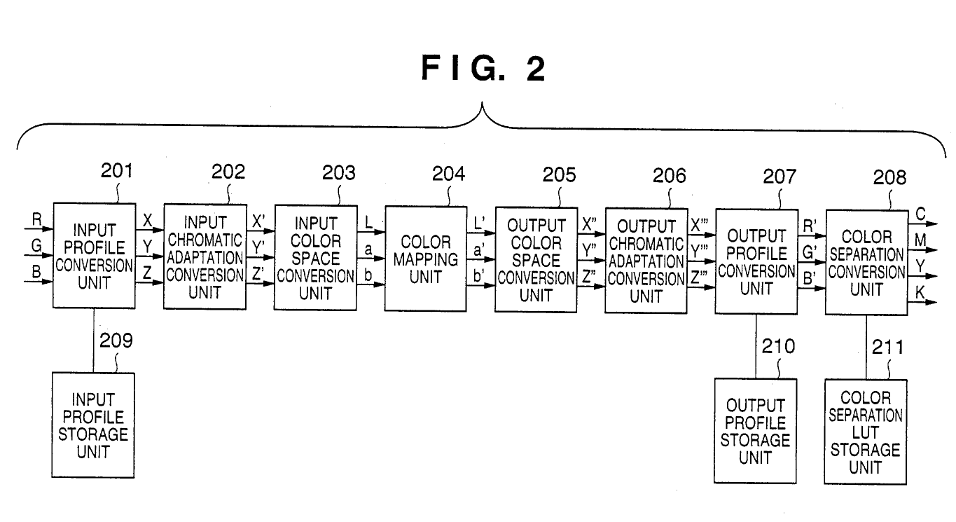

FIG. 2 shows the functional arrangement of the image processing unit 120, and processes in respective units which form the image processing unit 120 will be explained below. Color signals R, G, and B that form image data are converted into output color signals C, M, Y, and K by an input profile conversion unit 201, input chromatic adaptation conversion unit 202, input color space conversion unit 203, color mapping unit 203, output color space conversion unit 205, output chromatic adaptation conversion unit 206, output profile conversion unit 207, and color separation conversion unit 208.

The input profile conversion unit 201 converts input color signals R, G, and B into color signals X, Y, and Z on a CIEXYZ color space on the basis of a profile which represents the color reproduction characteristics of an input device, that is stored in an input profile storage unit 209. In general, as a default of profiles (to be referred to as input profiles hereinafter) stored in the input profile storage unit 209, sRGB specified by IEC61966-2-1 is used. In this case, the input profile conversion unit 201 converts input color signals R, G, and B into color signals X, Y, and Z on the CIEXYZ color space independent of image input/output devices (to be referred to as devices hereinafter) using a conversion formula based on sRGB. Use of sRGB as an input profile assumes that image data is based on sRGB.

The input chromatic adaptation conversion unit 202 corrects the influence of chromatic adaptation due to a different observation environment by a known method. For example, in environments of D65 and D50 white points, colors have different appearances even when color signals X, Y, and Z remain the same. Hence, the color signals are corrected to obtain the same appearance.

More specifically, color signals X, Y, and Z of an input image as tristimulus values in an observation environment are converted into tristimulus values X′, Y′, and Z′ that can obtain the same color appearance in a standard observation environment. In general, conversion based on the von Kries rules, chromatic adaptation model, color appearance model, or the like is used. When adaptation is not taken into consideration, the process of the input chromatic adaptation conversion unit 202 is omitted, and input color signals are directly output.

The input color space conversion unit 203 converts the input color signals X′, Y′, and Z′ on the CIEXYZ color space into color signals L, a, and b on a CIELAB color space on the basis of a conversion formula specified by Publication CIE No. 15.2. The color mapping unit 204 converts the color signals L, a, and b into color signals L′, a′, and b′ that can be reproduced by the image output apparatus 103. The output color space conversion unit 205 converts the color signal L′, a′, and b′ on the CIELAB color space into color signals X″, Y″, and Z″ on the CIEXYZ color space on the basis of a conversion formula specified by Publication CIE No. 15.2.

The output chromatic adaptation conversion unit 206 converts the signals X″, Y″, and Z″ as tristimulus values in the standard observation environment into tristimulus values X′″, Y′″, and Z′″ that can obtain the same color appearance in an observation environment of an output image. When adaptation is not taken into consideration, the process of the output chromatic adaptation conversion unit 206 is omitted, and input color signals are directly output. The output profile conversion unit 207 converts input color signals X′″, Y′″, and Z′″ into color signals R′, G′, and B′ depending on the image output apparatus 103 on the basis of a profile (to be referred to as an output profile hereinafter) which is stored in an output profile storage unit 210 and represents the color reproduction characteristics of the image output apparatus 103.

The output profile storage unit 210 typically stores color signals X′″, Y′″, and Z′″ corresponding to discrete color signals R′, G′, and B′ as a three-dimensional look-up table (to be abbreviated as 3D LUT hereinafter). The output profile conversion unit 207 searches the 3D LUT for data near the input color signals X′″, Y′″, and Z′″, and calculates output color signals R′, G′, and B′ based on the found data and input color signals using a known interpolation method. The color separation conversion unit 208 converts the input color signals R′, G′, and B′ into output color signals C, M, Y, and K by a known method using a color separation LUT stored in a color separation LUT storage unit 211.

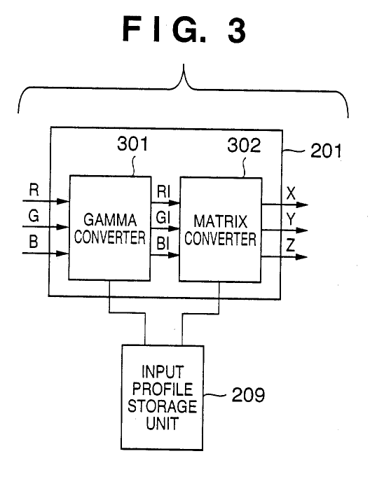

FIG. 3 shows the detailed functional arrangement of the input profile conversion unit 201. Input color signals R, G, and B are converted into color signals X, Y, and Z by a gamma converter 301 and matrix converter 302. When the input profile stored in the input profile storage unit 209 is based on sRGB, the gamma converter 301 converts input color signals R, G, and B into color signals RI, GI, and BI, which are linear with respect to luminance, by:

When (R/255)≦0.03928,

RI=(R/255)/12.92 (1)

When (R/255)>0.03928,

RI=((R/255)+0.055)/1.055)\hat{ }2.4 (2)

where x\hat{ }y indicates the y-th power of x. The gamma converter 301 generates GI and BI using equations (1) and (2) for the remaining signals G and B. When image data is based on color characteristics different from sRGB, for example, discrete input color signals (e.g., R) and corresponding output color signals (e.g., RI) are stored in the input profile storage unit 209 as a gamma conversion LUT. The gamma converter 301 converts arbitrary input color signals into output color signals with reference to the gamma conversion LUT.

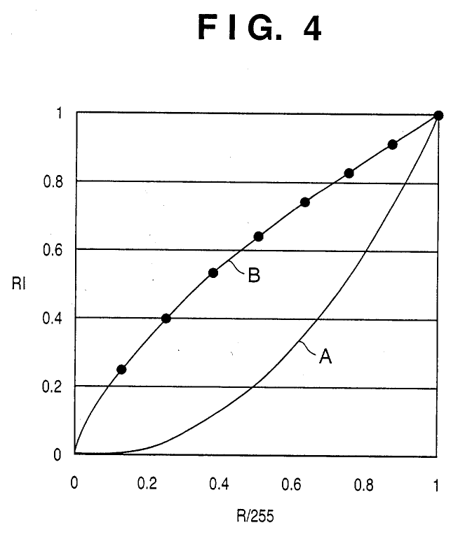

FIG. 4 illustrates the relationship between the input and output color signals stored in the gamma conversion LUT. The abscissa plots a normalized input color signal (e.g., R/255), and the ordinate plots an output color signal (e.g., RI). Curve A represents the relationship between the input and output color signals of sRGB based on equations (1) and (2), and curve B represents the relationship between the input and output color signals based on other color characteristics different from sRGB. The values of input and output color signals at plot points are stored in the input profile storage unit 209 as a gamma conversion LUT, and an output color signal between neighboring plot points is calculated by interpolation.

When the input profile is based on sRGB, the matrix converter 302 converts the input color signals RI, GI, and BI into color signals X, Y, and Z by:

$$[ \begin{matrix}X \\ Y \\ Z\end{matrix} ] [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}RI \\ CI \\ BI\end{matrix} ] \qquad ( 3 )$$

When image data is based on color characteristics different from sRGB, an conversion matrix, which indicates the color characteristics, can be stored in the input profile storage unit 209. The matrix converter 302 converts the color signals RI, GI, and BI into color signals X, Y, and Z using conversion matrix M stored in the input profile storage unit 209 by:

$$[ \begin{matrix}X \\ Y \\ Z\end{matrix} ] = M [ \begin{matrix}RI \\ CI \\ BI\end{matrix} ] \qquad ( 4 )$$

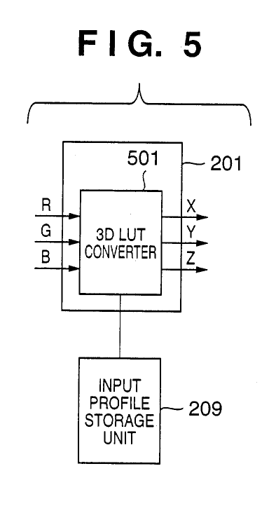

FIG. 5 shows another functional arrangement of the input profile conversion unit 201. In this example, input color signals R, G, and B are converted into color signals X, Y, and Z by a 3D LUT converter 501. In this case, output color signals corresponding to discrete input color signals R, G, and B are stored as a 3D LUT in the input profile storage unit 209. For example, the input profile storage unit 209 stores colorimetric values X, Y, and Z corresponding to grid points {R, G, B}={0, 0, 0}, (0, 0, 32}, . . . , {0, 0, 224}, (0, 0, 255}, {0, 32, 0}, {0, 32, 32}, . . . , {255, 255, 255}. The 3D LUT converter 501 converts arbitrary input color signals R, G, and B into color signals X, Y, and Z using this 3D LUT and a known interpolation method.

Encryption in this embodiment will be described below. Image encryption in this embodiment amounts to reading a high-resolution color image by a virtual image input apparatus (to be referred to as an encryption apparatus hereinafter) which has unique color reproduction characteristics different from sRGB. Since the color reproduction characteristics of the encryption apparatus are different from sRGB, a default color process that uses sRGB in the input profile storage unit 209 cannot satisfactorily output an image (to be referred to as an encrypted image hereinafter) read by the encryption apparatus. The encrypted image can be output with high quality, i.e., can be decrypted, only when a profile (to be referred to as an encryption profile hereinafter) serving as a key of encryption is set in the input profile storage unit 209. It should be noted that, when the decryption processing can not be done (the decryption processing using the encryption profile can not be done), one of cases as follow is happened.

1. An image having poor color reproduction is reproduce.

2. An image can not be reproduced.

According to type of encryption profile used for encryption, it is determined which case is happened.

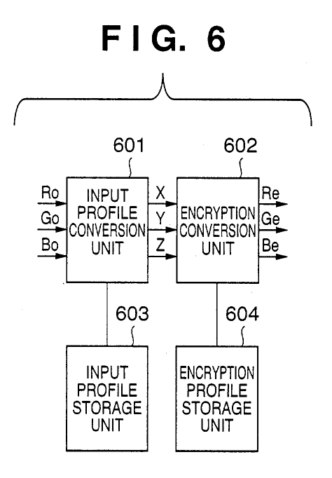

FIG. 6 is a block diagram showing the functional arrangement of an image encryption apparatus in this embodiment. Color signals Ro, Go, and Bo which form an image to be encrypted (to be referred to as a to-be-encrypted image hereinafter) are converted by an input profile conversion unit 601 into color signals X, Y, and Z, which are converted by an encryption conversion unit 602 into color signals Re, Ge, and Be which form an encrypted image. The input profile conversion unit 601 executes the same process as that executed by the input profile conversion unit 201 shown in FIG. 2, and converts signals Ro, Go, and Bo of a to-be-encrypted image into color signals X, Y, and Z on a device-independent color space.

When the color characteristics of a to-be-encrypted image are based on sRGB, input color signals Ro, Go, Bo are converted into color signals X, Y, and Z by equations (1), (2), and (3) above. The encryption conversion unit 602 converts the input color signals X, Y, and Z into color signals Re, Ge, and Be on the basis of an encryption profile stored in an encryption profile storage unit 604. This process executes inverse conversion of the conversion executed by the input profile conversion unit 201 when the encryption profile is stored in the input profile storage unit 209 in FIG. 2. When the encryption profile storage unit 604 stores a gamma conversion LUT and conversion matrix M based on the encryption profile, and the encryption conversion unit 602 executes inverse conversion of the conversion from color signals R, G, and B into color signals X, Y, and Z, which has been explained using FIG. 3, the encryption conversion unit 602 calculates RI, GI, and BI by:

$$[ \begin{matrix}RI \\ CI \\ BI\end{matrix} ] = {M}^{- 1} [ \begin{matrix}X \\ Y \\ Z\end{matrix} ] \qquad ( 5 )$$

as inverse conversion of equation (4).

Then, an inverse conversion process of the conversion executed by the gamma converter 301 is executed to convert the color signals RI, GI, BI into color signals Re, Ge, and Be. More specifically, conversion which has the ordinate of FIG. 4 as an input color signal and the abscissa of FIG. 4 as an output color signal is executed.

On the other hand, when the encryption profile storage unit 604 stores a 3D LUT based on the encryption profile and the encryption conversion unit 602 executes inverse conversion of the conversion from color signals R, G, and B into color signals X, Y, and Z which has been explained using FIG. 5, the encryption conversion unit 602 searches the 3D LUT for a grid point near the input color signals X, Y, and Z, and calculates output color signals Re, Ge, and Be using a known interpolation method on the basis of the found grid point data and the input color signals.

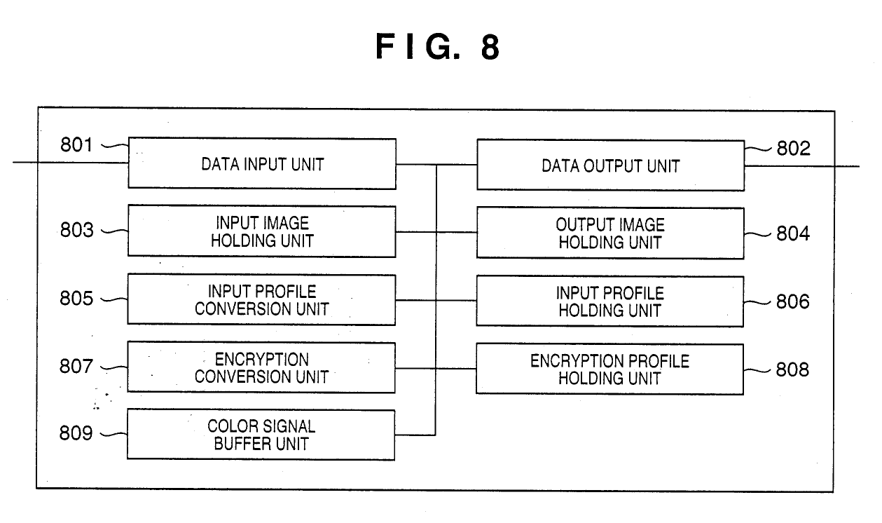

FIG. 8 shows the basic arrangement of the image encryption apparatus of this embodiment. As shown in FIG. 8, the image encryption apparatus of this embodiment comprises a data input unit 801, data output unit 802, input image holding unit 803, output image holding unit 804, input profile conversion unit 805, input profile holding unit 806, encryption conversion unit 807, encryption profile holding unit 808, and color signal buffer unit 809.

The input image holding unit 803 stores to-be-encrypted image data input via the data input unit 801. The input profile holding unit 806 stores an input profile (that which is stored in the input profile storage unit 603) input via the data input unit 801. The encryption profile holding unit 808 stores an encryption profile (that which is stored in the encryption profile storage unit 604). The encryption profile holding unit 808 may pre-store an encryption profile or may store a new encryption profile input via the data input unit 801.

The input profile conversion unit 805 converts color signals, which form an image stored in the input image holding unit 803, into device-independent color signals, using an input profile stored in the input profile holding unit 806, and stores them in the color signal buffer unit 809. The encryption conversion unit 807 converts the color signals that the input profile conversion unit 805 stores in the color signal buffer unit 809 into color signals Re, Ge, and Be which form an encrypted image, using an encryption profile stored in the encryption profile holding unit 808, and stores them in the output image holding unit 804. The encrypted image stored in the output image holding unit 804 is externally output via the data output unit 802, and is saved/distributed as in a normal image.

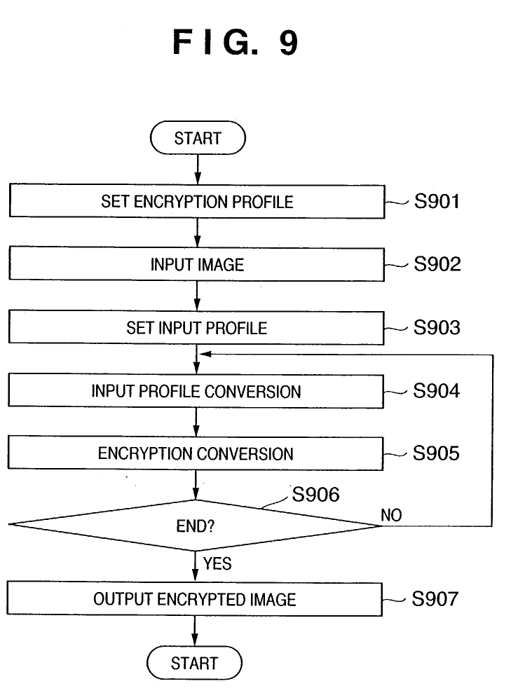

The image encryption process executed by the image encryption apparatus will be described below using FIG. 9 which is a flow chart of that process.

In step S901, an encryption profile to be used is set. The encryption profile may be set by selecting one of a plurality of encryption profiles pre-stored in the encryption profile holding unit 808 or inputting a new encryption profile via the data input unit 801. In step S902, to-be-encrypted image data is input via the data input unit 801, and is stored in the input image holding unit 803. In step S903, an input profile of the to-be-encrypted image data is set. If the to-be-encrypted image data is scanned by a scanner, the profile of the corresponding scanner is set; if the to-be-encrypted image data is based on sRGB, an sRGB profile is set and stored in the input profile holding unit 806. The input profile may be set by selecting one of a plurality of input profiles pre-stored in the input profile holding unit 806 or by inputting a new input profile via the data input unit 801.

In step S904, an input profile conversion process is executed. The input profile conversion process converts color signals which form the input image data stored in the input image holding unit 803 in step S902 into device-independent color signals X, Y, and Z using the input profile set in step S903. In step S905, an encryption conversion process is executed. The encryption conversion process converts the color signals X, Y, and Z into color signals Re, Ge, and Be, which form encrypted image data, using the encryption profile set in step S901. It is then checked in step S906 if all color signals which form the input image data have been processed. If color signals to be processed still remain, the flow returns to step S904; otherwise, the flow advances to step S907. In step S907, the generated encrypted image is output.

A process for decrypting the encrypted image data generated by the image encryption apparatus will be described below. The decryption process of this embodiment does not require any special apparatus or software program since it uses processes in the image processing apparatus. That is, in the general image process that has been explained using FIG. 2, the encryption profile used upon encrypting the to-be-encrypted image is set in the input profile storage unit 209, and is used, thereby decrypting the encrypted image data.

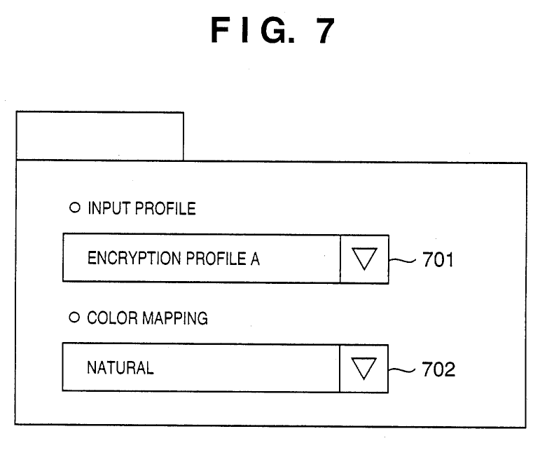

FIG. 7 shows an example of a setup user interface (GUI) of a typical color printer program, which is displayed on the display unit 1705. With this GUI, the types of input profile and color mapping are designated using an input profile list box 701 and color mapping list box 702. The decryption process is implemented by designating the encryption profile in the input profile list box 701.

As described above, the image encryption apparatus of this embodiment uses the color profile of a virtual image input apparatus having unique color reproduction characteristics as a key of decryption. As a result, simple image decryption that exploits the existing image process can be realized. The encrypted image data generated by the image encryption apparatus of this embodiment can be used in a general image processing apparatus/software program as in normal image data, and need not use any special software program. Furthermore, since the encrypted image data can be decrypted only when the user has the color profile as the key of decryption, secondary distributions are suppressed, and the limitation of users can be made securer.

### Second Embodiment

In the first embodiment, an image encryption apparatus that exploits an input profile is formed. Likewise, an image encryption apparatus that exploits an output profile can be formed. The image encryption apparatus of this embodiment uses a color profile of a virtual image output apparatus having unique color reproduction characteristics as a key of decryption. An encrypted image generated by this image encryption apparatus can be decrypted by storing an encryption profile in the output profile storage unit 210 and using this encryption profile by the output profile conversion unit 207 in the image processing unit shown in FIG. 2.

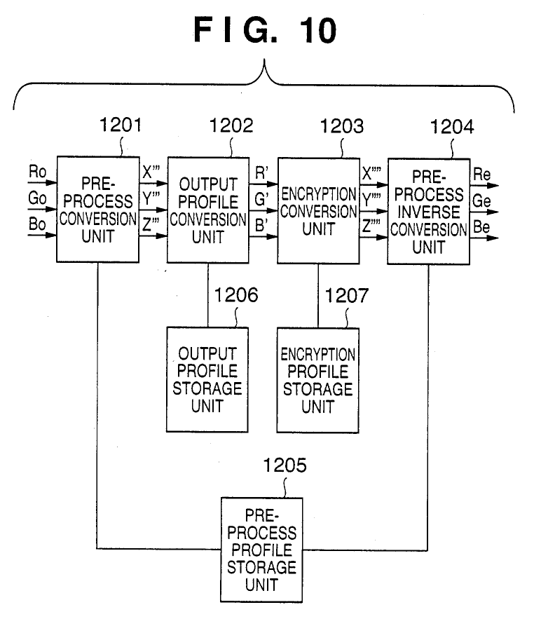

Encryption in this embodiment will be described below. FIG. 10 shows the functional arrangement of the image encryption apparatus of this embodiment. Color signals Ro, Go, and Bo, which form a to-be-encrypted image, are converted into color signals Re, Ge, and Be, which form an encrypted image, by a pre-process conversion unit 1201, output profile conversion unit 1202, encryption conversion unit 1203, and pre-process inverse conversion unit 1204.

Note that the color signals Ro, Go, and Bo, and Re, Ge, and Be are those on a color space which form image data, color signals X′″, Y′″, and Z′″, and X″″, Y″″, and Z″″ are those on a device-independent color space, and color signals R′, G′, and B′ are those on a color space depending on the image output apparatus 103. The pre-process conversion unit 1201 executes processes to be executed by the input profile conversion unit 201, input chromatic adaptation conversion unit 202, input color space conversion unit 203, color mapping unit 204, output color space conversion unit 205, and output chromatic adaptation conversion unit 206 in the description using FIG. 2. Typically, a 3D LUT of color signals X′″, Y′″, and Z′″ corresponding to discrete color signals Ro, Go, and Bo is stored as a pre-process profile in a pre-process profile storage unit 1205, and is used. The pre-process conversion unit 1201 converts input color signals Ro, Go, and Bo into output color signals X′″, Y′″, and Z′″ using the 3D LUT stored in the pre-process profile storage unit 1205, and a known interpolation method.

The output profile conversion unit 1202 executes the same process as that of the output profile conversion unit 207 in FIG. 2, and converts the input color signals X′″, Y′″, and Z′″ into color signals R′, G′, and B′ on the basis of an output profile stored in an output profile storage unit 1206.

The encryption conversion unit 1203 converts the input color signals R′, G′, and B′ into output color signals X″″, Y″″, and Z″″ using an encryption profile stored in an encryption profile storage unit 1207. This process executes inverse conversion of the conversion to be executed by the output profile conversion unit 207 when the encryption profile is stored in the output profile storage unit 210 in FIG. 2.

The pre-process inverse conversion unit 1204 executes inversion conversion of the conversion executed by the pre-process conversion unit 1201. Typically, the 3D LUT stored in the pre-process profile storage unit 1205 are searched for data near the input color signals X″″, Y″″, and Z″″, and output color signals Re, Ge, and Be are calculated using a known interpolation method on the basis of the found data and input color signals.

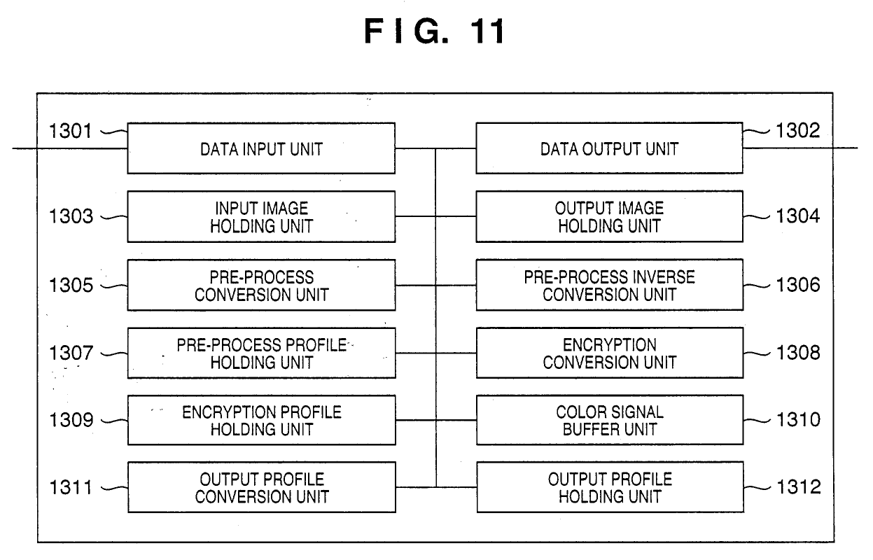

FIG. 11 shows the basic arrangement of the image encryption apparatus. As shown in FIG. 11, the image encryption apparatus of this embodiment comprises a data input unit 1301, data output unit 1302, input image holding unit 1303, output image holding unit 1304, pre-process conversion unit 1305, pre-process inverse conversion unit 1306, pre-process profile holding unit 1307, encryption conversion unit 1308, encryption profile holding unit 1309, color signal buffer unit 1310, output profile conversion unit 1311, and output profile holding unit 1312.

The input image holding unit 1303 stores to-be-encrypted image data input via the data input unit 1301. The encryption profile holding unit 1309 stores the encryption profile. The encryption profile holding unit 1309 may pre-store the encryption profile or may store a new encryption profile input via the data input unit 1301. The pre-process profile holding unit 1307 stores the pre-process profile. The pre-process profile holding unit 1307 may pre-store the pre-process profile or may store a new pre-process profile input via the data input unit 1301.

The pre-process conversion unit 1305 converts color signals, which form an image stored in the input image holding unit 1303, into color signals on a device-independent color space using the pre-process profile stored in the pre-process profile holding unit 1307, and stores the converted color signals in the color signal buffer unit 1310. The output profile conversion unit 1311 converts the color signals that the pre-process conversion unit 1305 stores in the color signal buffer unit 1310 into color signals on a color space depending on the image output apparatus 103 using the output profile stored in the output profile holding unit 1312, and stores the converted color signals in the color signal buffer unit 1310. The encryption conversion unit 1308 converts the color signals that the output profile conversion unit 1311 stores in the color signal buffer unit 1310 into color signals on a device-independent color space using the encryption profile stored in the encryption profile holding unit 1309, and stores the converted color signals in the color signal buffer unit 1310. The pre-process inverse conversion unit 1306 converts the color signals that the encryption conversion unit 1308 stores in the color signal buffer unit 1310 into color signals which form an encrypted image using the pre-process profile stored in the pre-process profile holding unit 1307, and stores the converted color signals in the output image holding unit 1304. The encrypted image stored in the output image holding unit 1304 is output via the data output unit 1302.

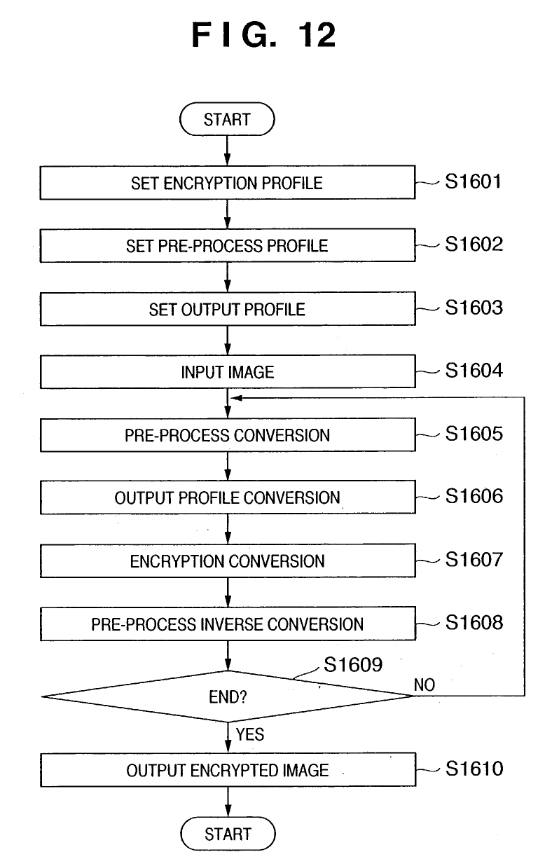

FIG. 12 is a flow chart of the image encryption process executed by the image encryption apparatus of this embodiment.

In step S1601, an encryption profile to be used is set. The encryption profile may be set by selecting one of a plurality of encryption profiles pre-stored in the encryption profile holding unit 1309 or inputting a new encryption profile via the data input unit 1301. In step S1602, a pre-process profile to be used is set. The pre-process profile may be set by selecting one of a plurality of pre-process profiles pre-stored in the pre-process profile holding unit 1307 or inputting a new pre-process profile via the data input unit 1301. In step S1603, an output profile to be used is set. The output profile may be set by selecting one of a plurality of output profiles pre-stored in the output profile holding unit 1312 or inputting a new output profile via the data input unit 1301.

In step S1604, to-be-encrypted image data is input via the data input unit 1301, and is stored in the input image holding unit 1303. In step S1605, pre-process conversion is executed. The pre-process conversion converts color signals, which form the input image data, into color signals X′″, Y′″, and Z′″ on a device-independent color space using the pre-process profile set in step S1602. In step S1606, output profile conversion is executed. The output profile conversion converts the color signals X′″, Y′″, and Z′″ into color signals R′, G′, and B′ on a color space depending on the image output apparatus 103 using the output profile set in step S1603.

In step S1607, encryption conversion is executed. The encryption conversion converts the color signals R′, G′, and B′ into color signals X″″, Y″″, and Z″″ on a device-independent color space using the encryption profile set in step S1601. In step S1608, pre-process inverse conversion is executed. The pre-process inverse conversion converts the color signals X″″, Y″″, and Z″″ into color signals Re, Ge, and Be which form encrypted image data using the pre-process profile set in step S1602. It is then checked in step S1609 if all color signals that form the to-be-encrypted image data have been processed. If color signals to be processed still remain, the flow returns to step S1605; otherwise, the flow advances to step S1610. Finally, in step S1610 the generated encrypted image is output.

A-process for decrypting the encrypted image data generated by the image encryption apparatus will be explained below. The decryption process of this embodiment does not require any special apparatus or software program since it uses processes in the image processing apparatus. That is, in the general image process that has been explained using FIG. 2, the encryption profile used upon encrypting the to-be-encrypted image is set in the output profile storage unit 210, and is used, thereby decrypting the encrypted image data.

### Third Embodiment

Also, an image encryption apparatus which is compatible to an image processing apparatus that uses an input/output integrated profile that integrates input and output profiles may be formed. An image encryption apparatus of this embodiment uses an input/output integrated profile having unique color reproduction characteristics as a key of decryption.

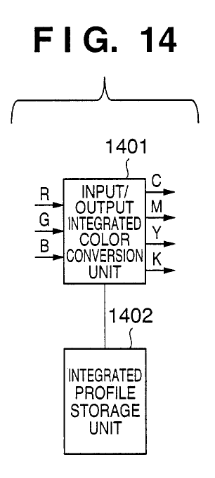

FIG. 14 shows the functional arrangement of an image processing apparatus that uses an input/output integrated profile. The image processing apparatus comprises an input/output integrated color conversion unit 1401, and integrated profile storage unit 1402. The input/output integrated color conversion unit 1401 executes processes to be executed by the input profile conversion unit 201, input chromatic adaptation conversion unit 202, input color space conversion unit 203, color mapping unit 204, output color space conversion unit 205, output chromatic adaptation conversion unit 206, output profile conversion unit 207, color separation conversion unit 208 in FIG. 2. Typically, a 3D LUT of color signals C, M, Y, and K corresponding to discrete input color signals R, G, and B is stored as an integrated profile in the integrated profile storage unit 1402, and is used. An encrypted image generated by this image encryption apparatus is decrypted in such a manner that an encryption profile is stored in the integrated profile storage unit 1402, and is used by the input/output integrated color conversion unit 1401.

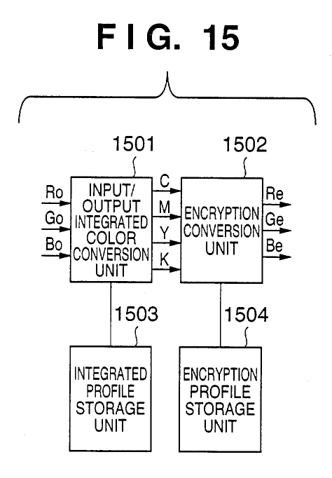

Encryption of this embodiment will be explained below. FIG. 15 shows the functional arrangement of the image encryption apparatus of this embodiment. Color signals Ro, Go, and Bo which form a to-be-encrypted image are converted into color signals Re, Ge, and Be that form an encrypted image by an input/output integrated color conversion unit 1501 and encryption conversion unit 1502.

The input/output integrated color conversion unit 1501 executes the same process as in the input/output integrated color conversion unit 1401 in FIG. 14, and converts color signals Ro, Go, and Bo which form a to-be-encrypted image into color signals C, M, Y, and K to be output to the image output apparatus 103 on the basis of an integrated profile stored in an integrated profile storage unit 1503.

The encryption conversion unit 1502 converts the input color signals C, M, Y, and K into color signals Re, Ge, and Be that form an encrypted image on the basis of an encryption profile stored in an encryption profile storage unit 1504. This process executed inverse conversion of the conversion to be executed by the input/output integrated color conversion unit 1401 when the encryption profile is stored in the integrated profile storage unit 1402 in FIG. 14. Typically, a 3D LUT stored in the encryption profile storage unit 1504 is searched for data near the input color signals C, M, Y, and K, and output color signals Re, Ge, and Be are calculated using a known interpolation method on the basis of the found data and the input color signals.

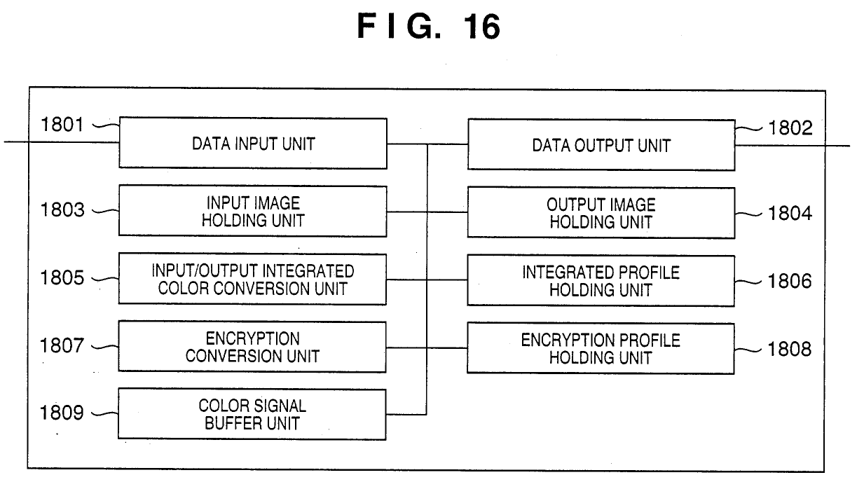

FIG. 16 shows the basic arrangement of the image encryption apparatus. As shown in FIG. 16, the image encryption apparatus of this embodiment comprises a data input unit 1801, data output unit 1802, input image holding unit 1803, output image holding unit 1804, input/output integrated color conversion unit 1805, integrated profile holding unit 1806, encryption conversion unit 1807, encryption profile holding unit 1808, and color signal buffer unit 1809.

The input image holding unit 1803 stores to-be-encrypted image data input via the data input unit 1801. The integrated profile holding unit 1806 stores the integrated profile. The integrated profile holding unit 1806 may pre-store the integrated profile, or may store a new integrated profile input via the data input unit 1801. The encryption profile holding unit 1808 stores the encryption profile. The encryption profile holding unit 1808 may pre-store the encryption profile, or may store a new encryption profile input via the data input unit 1801.

The input/output integrated color conversion unit 1805 converts color signals that form the input image stored in the input image holding unit 1803 into color signals to be output to the image output apparatus 103 using the integrated profile stored in the integrated profile holding unit 1306, and stores the converted color signals in the color signal buffer unit 1809. The encryption conversion unit 1807 converts the color signals that the input/output integrated color conversion unit 1805 stores in the color signal buffer unit 1809 into color signals that form an encrypted image using the encryption profile stored in the encryption profile holding unit 1808, and stores the converted color signals in the output image holding unit 1804. The encrypted image stored in the output image holding unit 1804 is output via the data output unit 1802.

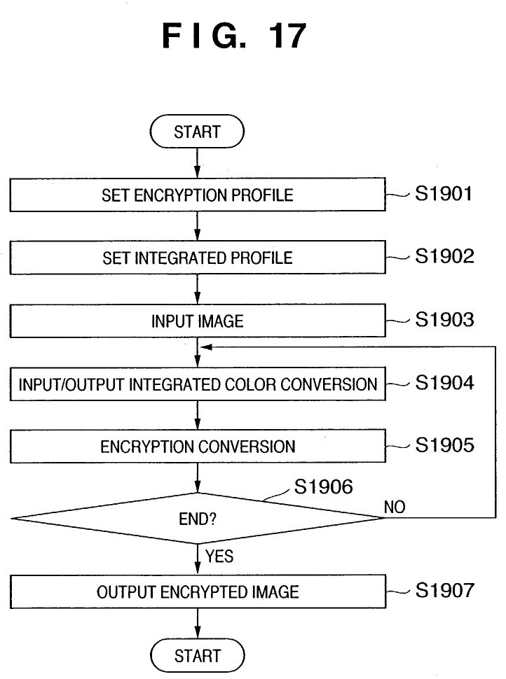

FIG. 17 is a flow chart of the image encryption process executed by the image encryption apparatus of this embodiment.

In step S1901, an encryption profile to be used is set. The encryption profile may be set by selecting one of a plurality of encryption profiles pre-stored in the encryption profile holding unit 1808 or inputting a new encryption profile via the data input unit 1801. In step S1902, an integrated profile to be used is set. The integrated profile may be set by selecting one of a plurality of integrated profiles pre-stored in the integrated profile holding unit 1806 or inputting a new integrated profile via the data input unit 1801.

In step S1903, to-be-encrypted image data is input via the data input unit 1801, and is stored in the input image holding unit 1803. In step S1904, input/output integrated color conversion is executed. The input/output integrated color conversion converts color signals which form the input image data into color signals C, M, Y, and K to be output to the image output apparatus 103 using the integrated profile set in step S1902.

In step S1905, encryption conversion is executed. The encryption conversion converts the color signals C, M, Y, and K to be output to the image output apparatus 103 into color signals Re, Ge, and Be that form encrypted image data using the encryption profile set in step S1901. It is then checked in step S1906 if all color signals which form the to-be-encrypted image data have been processed. If color signals to be processed still remain, the flow returns to step S1904; otherwise, the flow advances to step S1907. Finally, in step S1907 the generated encrypted image is output.

### Another Embodiment

In the above embodiments, a color printer using four colors, i.e., C, M, Y, and K has been exemplified as the image output apparatus. However, the object of the present invention can also be achieved by color printers of other arrangements.

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used. The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As described above, the present invention can implement image encryption that allows decryption without requiring any special software program or apparatus. Also, the present invention can decrypt an encrypted image without requiring any special software program or apparatus. As a result, users of a high-resolution image can be easily limited.

Other features and advantages of the present invention will be apparent from the following description taken in conjunction with the accompanying drawings, in which like reference characters designate the same or similar parts throughout the figures thereof.

As many apparently widely different embodiments of the present invention can be made without departing from the spirit and scope thereof, it is to be understood that the invention is not limited to the specific embodiments thereof except as defined in the appended claims.

What is claimed is:

1. An image encryption apparatus for encrypting an image, comprising:
first conversion means for converting a color signal group that forms a first image into a color signal group, that is independent of a device supplying the first image, on the basis of a first profile; and
second conversion means for converting the color signal group, converted by said first conversion means into a color signal group that forms a second image different from the first image, on the basis of a second profile used for encryption which is different from encryption by the first profile.

2. The apparatus according to claim 1, wherein said first conversion means converts color signals R, G, and B that form the first image on the basis of an sRGB profile.

3. The apparatus according to claim 1, wherein said second conversion means converts the color signal group converted by said first conversion means into the color signal group that forms the second image using a gamma conversion LUT based on the second profile, and a predetermined conversion matrix.

4. A decryption apparatus for decrypting an image encrypted by an image encryption apparatus of claim 1, comprising:
conversion means for converting the second image into a color signal, that is independent of the device supplying the first image, on the basis of the second profile; and
output means for generating output image data on the basis of the color signal group converted by said conversion means, and outputting the output image data to an image forming apparatus.

5. An image encryption method for encrypting an image, comprising:
a first conversion step of converting a color signal group that forms a first image into a color signal group, that is independent of a device supplying the first image, on the basis of a first profile; and
a second conversion step of converting the color signal group, converted in the first conversion step into a color signal group that forms a second image different from the first image, on the basis of a second profile used for encryption which is different from encryption by the first profile.

6. A decryption method for decrypting an image encrypted by an image encryption method of claim 5, comprising:
a conversion step of converting the second image into a color signal, that is independent of the device supplying the first image, on the basis of the second profile; and
an output step of generating output image data on the basis of the color signal group converted in the conversion step, and outputting the output image data to an image forming apparatus.

7. A program for making a computer function as an image encryption apparatus of claim 1.

8. A program for making a computer function as a decryption apparatus of claim 4.

9. A program for making a computer execute an image encryption method of claim 5.

10. A program for making a computer execute a decryption method of claim 6.

11. An image encryption apparatus for encrypting an image, comprising:
first conversion means for converting a color signal group that forms a first image into a first color signal group, which is independent of a device, on the basis of a first profile;
second conversion means for converting the first color signal group into a color signal group on a color space of an image forming apparatus on the basis of a second profile which is different from the first profile;
third conversion means for converting the color signal group converted by said second conversion means into a second color signal group on the basis of a third profile, which is used for encryption which is different from encryption by the first and the second profiles; and
fourth conversion means for converting the second color signal group into a color signal group that forms a second image by executing inverse conversion of the conversion by said first conversion means on the basis of the first profile.

12. The apparatus according to claim 11, wherein said third conversion means converts the color signal group on the color space of the image forming apparatus into the second color signal group using a three-dimensional LUT that expresses the second color signal group, based on the third profile, which are corresponding to color signals R, G, and B as a color signal group on a color space of the image forming apparatus.

13. A decryption apparatus for decrypting an image encrypted by an image encryption apparatus of claim 11, comprising:
fourth conversion means for converting the color signal group which forms the second image into a third color signal group on the basis of the first profile;
fifth conversion means for converting the third signal group into a color signal group on the color space of the image forming apparatus on the basis of the third profile; and
output means for generating output image data based on the color signal group converted by said fifth conversion means, and outputting the output image data to the image forming apparatus.

14. An image encryption method for encrypting an image, comprising:
a first conversion step of converting a color signal group that forms a first image into a first color signal group, which is independent of a device, on the basis of a first profile;
a second conversion step of converting the first color signal group into a color signal group on a color space of an image forming apparatus on the basis of a second profile which is different from the first profile;
a third conversion step of converting the color signal group converted in the second conversion step into a second color signal group on the basis of a third profile, which is used for encryption which is different from encryption by the first and the second profiles; and
a fourth conversion step of converting the second color signal group into a color signal group that forms a second image by executing inverse conversion of the conversion in the first conversion step on the basis of the first profile.

15. A decryption method for decrypting an image encrypted by an image encryption method of claim 14, comprising:
a fourth conversion step of converting the color signal group which forms the second image into a third color signal group on the basis of the first profile;
a fifth conversion step of converting the third signal group into a color signal group on the color space of the image forming apparatus on the basis of the third profile; and
an output step of generating output image data based on the color signal group converted in the fifth conversion step, and outputting the output image data to the image forming apparatus.

16. A program for making a computer function as an image encryption apparatus of claim 11.

17. A program for making a computer function as a decryption apparatus of claim 13.

18. A program for making a computer execute an image encryption method of claim 14.

19. A program for making a computer execute a decryption method of claim 15.

20. An image encryption apparatus for encrypting an image, comprising:
first conversion means for converting a color signal group that forms a first image into a color signal group on a color space of an image forming apparatus on the basis of a first profile; and
second conversion means for converting the color signal group converted by said first conversion means into a color signal group that forms a second image different from the first image, on the basis of a second profile which is used for encryption which is different from encryption by the first profile.

21. The apparatus according to claim 20, wherein said first conversion means converts color signals R, G, and B which form the first image on the basis of an integrated profile as a three-dimensional LUT of color signals C, M, Y, and K corresponding to discrete input color signals R, G, and B.

22. The apparatus according to claim 20, wherein said second conversion means converts the color signal group on the color space of the image forming apparatus on the basis of the second profile as a three-dimensional LUT of color signals R, G, and B corresponding to discrete color signals C, M, Y, and K.

23. A decryption apparatus for decrypting an image encrypted by an image encryption apparatus of claim 20, comprising:
conversion means for converting the second image into a color signal group on the color space of the image forming apparatus on the basis of the second profile; and
output means for generating output image data on the basis of the color signal group converted by said conversion means, and outputting the output image data to the image forming apparatus.

24. An image encryption method for encrypting an image, comprising:
a first conversion step of converting a color signal group that forms a first image into a color signal group on a color space of an image forming apparatus on the basis of a first profile; and
a second conversion step of converting the color signal group converted in the first conversion step into a color signal group that forms a second image different from the first image, on the basis of a second profile which is used for encryption which is different from encryption by the first profile.

25. A decryption method for decrypting an image encrypted by an image encryption method of claim 24, comprising:
a conversion step of converting the second image into a color signal group on the color space of the image forming apparatus on the basis of the second profile; and
an output step of generating output image data on the basis of the color signal group converted in the conversion step, and outputting the output image data to the image forming apparatus.

26. A program for making a computer function as an image encryption apparatus of claim 20.

27. A program for making a computer function as a decryption apparatus of claim 23.

28. A program for making a computer execute an image encryption method of claim 24.

29. A programw for making a computer execute a decryption method of claim 25.

30. A computer readable storage medium storing a program of claim 9.

31. A computer readable storage medium storing a program of claim 10.

32. A computer readable storage medium storing a program of claim 18.

33. A computer readable storage medium storing a program of claim 19.

34. A computer readable storage medium storing a program of claim 28.

35. A computer readable storage medium storing a program of claim 29.
